(19) United States
(12) Patent Application Publication
(10) Pub. No.: US 2026/0264394 A1
(43) Pub. Date: Sep. 10, 2026

(54) LIQUID DISCHARGE HEAD AND LIQUID DISCHARGE APPARATUS

(71) Applicants: Naoyuki TAKEZOE, Kanagawa (JP); Ryuji TSUKAMOTO, Kanagawa (JP)

(72) Inventors: Naoyuki TAKEZOE, Kanagawa (JP); Ryuji TSUKAMOTO, Kanagawa (JP)

(21) Appl. No.: 19/449,463

(22) Filed: Jan. 15, 2026

(30) Foreign Application Priority Data
Mar. 10, 2025 (JP) 2025-037506

(51) Int. Cl. B41J 2/045; B41J 2/14

(52) U.S. Cl. CPC B41J 2/04525; B41J 2/04581; B41J 2/14233; B41J 2/1433; B41J 2002/14419; B41J 2002/14459; B41J 2202/11

(57) ABSTRACT

A liquid discharge head includes a nozzle plate having multiple nozzles; multiple individual channels respectively communicating with the multiple nozzles; multiple actuators in the nozzle plate; a common channel communicating with each of the multiple individual channels; and a damper chamber. The multiple actuators respectively surround the multiple nozzles, to deform the nozzle plate to discharge a liquid in the multiple individual channels from the multiple nozzles. The common channel communicates with each of the multiple individual channels. The damper chamber communicates with the common channel; faces the nozzle plate; and is independent from each of the multiple individual channels.

### CROSS-REFERENCE TO RELATED APPLICATION

This patent application is based on and claims priority pursuant to 35 U.S.C. § 119(a) to Japanese Patent Application No. 2025-037506, filed on Mar. 10, 2025, in the Japan Patent Office, the entire disclosure of which is hereby incorporated by reference herein.

### BACKGROUND

### Technical Field

The present disclosure relates to a liquid discharge head and a liquid discharge apparatus.

### Related Art

A liquid discharge head has been developed, which includes multiple nozzles formed in a nozzle plate, multiple individual channels respectively communicating with the multiple nozzles, multiple actuators provided in the nozzle plate for each of the multiple individual channels, and a common channel communicating with the multiple individual channels.

### SUMMARY

The present disclosure herein provides a liquid discharge head including a nozzle plate having multiple nozzles; multiple individual channels respectively communicating with the multiple nozzles; multiple actuators in the nozzle plate; a common channel communicating with each of the multiple individual channels; and a damper chamber. The multiple actuators respectively surround the multiple nozzles, to deform the nozzle plate to discharge a liquid in the multiple individual channels from the multiple nozzles. The common channel communicates with each of the multiple individual channels. The damper chamber communicates with the common channel; faces the nozzle plate; and is independent from each of the multiple individual channels.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a cross-sectional view schematically illustrating a liquid discharge head according to an embodiment of the present disclosure;

FIG. 2 is an enlarged cross-sectional view illustrating a peripheral configuration of one individual channel in a liquid discharge head according to an embodiment of the present disclosure;

FIGS. 3A to 3C are exploded views of a liquid discharge head;

FIG. 4 is a diagram of a common channel of a common channel substrate in the liquid discharge head as viewed from an individual channel side;

FIG. 5 is a diagram illustrating a common channel substrate in a liquid discharge head;

FIG. 6A is a diagram of a liquid discharge head not provided with damper liquid chambers, according to a comparative example;

FIG. 6B is a diagram of a liquid discharge head provided with damper liquid chambers;

FIGS. 7A and 7B are graphs indicating results of a simulation (numerical calculation) performed to confirm a damper effect of a nozzle plate;

FIG. 8 is a diagram illustrating a schematic configuration of a liquid discharge head according to a first modification;

FIG. 9A is a diagram illustrating part of a liquid discharge head not provided with damper liquid chambers;

FIG. 9B is a diagram illustrating part of the liquid discharge head according to the first modification provided with the damper liquid chambers;

FIG. 10 is a diagram illustrating a schematic configuration of a liquid discharge head according to a second modification;

FIG. 11A is a diagram illustrating part of a liquid discharge head not provided with damper liquid chambers;

FIG. 11B is a diagram illustrating part of the liquid discharge head according to the second modification provided with the damper liquid chambers;

FIG. 12 is a diagram illustrating a schematic configuration of a liquid discharge head according to a modification;

FIG. 13 is a diagram of a printing apparatus according to an embodiment of the present disclosure;

FIG. 14 is a diagram of a head unit of the printing apparatus according to an embodiment of the present disclosure;

FIG. 15 is a diagram of a portion of a printing apparatus;

FIG. 16 is a diagram of a portion of a printing apparatus;

FIG. 17 is a diagram of a portion of a liquid discharge unit; and

FIG. 18 is a diagram of a liquid discharge unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In related art, there has been disclosed a liquid discharge head including a nozzle plate (nozzle plate) on which multiple nozzles and actuators is formed and a substrate on which multiple cylindrical pressure chambers (individual channels) respectively communicating with the multiple nozzles is formed. The actuators are formed in an annular shape coaxial with the nozzles, and are driven to pressurize liquid in each pressure chamber. In the liquid discharge head, a damper member made of an elastic member is provided in a pressure chamber on the side opposite to the nozzle plate side. The damper member is configured such that multiple cylindrical damper chambers having the same inner diameter as each of the pressure chambers respectively faces the pressure chambers, and a common liquid chamber (common channel) communicates with each of the pressure chambers via each of the damper chambers. A pressure wave or pressure fluctuation of the liquid caused by driving of the actuators in each pressure chamber is absorbed by elastic deformation of the damper chamber of the damper member, whereby crosstalk in which the pressure wave is propagated to other pressure chambers is reduced or prevented.

However, in the liquid discharge head in the related art, there is a problem that arrangement of the damper member for reducing or preventing crosstalk causes increase in size of the apparatus.

According to one aspect of the present disclosure, it is possible to reduce or prevent crosstalk without increasing the size of the apparatus.

Hereinafter, an embodiment of the present disclosure is applied to a liquid discharge head provided in a liquid discharge apparatus will be described.

The present disclosure is not limited to the embodiment described below and may be other embodiments than the embodiment described below. The following embodiment may be modified by, for example, addition, modification, or omission within the scope that would be obvious to one skilled in the art. Any aspect having function and effect according to an embodiment of the present disclosure is included within the scope of the present disclosure.

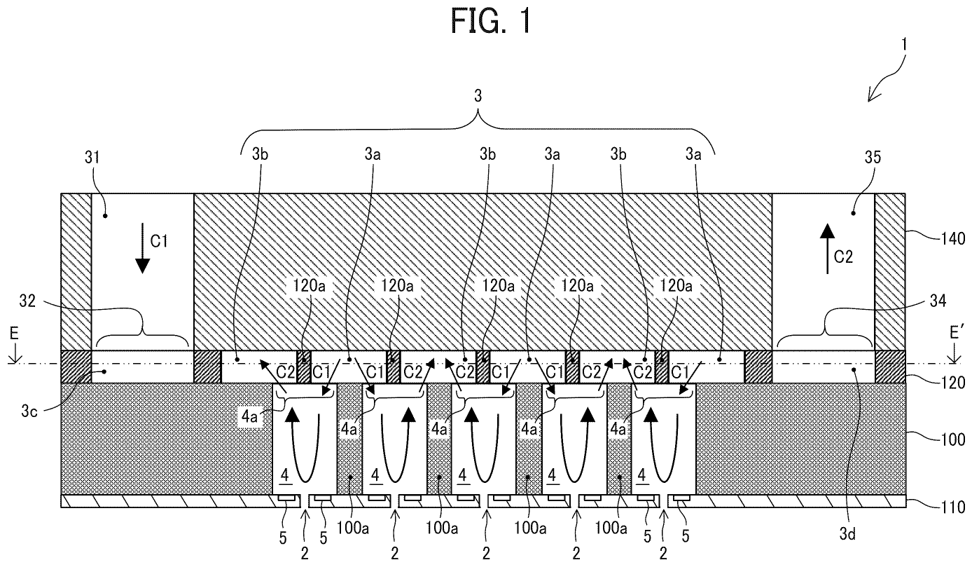

FIG. 1 is a cross-sectional view schematically illustrating a liquid discharge head of a nozzle plate vibration type according to the present embodiment.

The liquid discharge head 1 according to the present embodiment is a liquid discharge head of a nozzle plate vibration type that discharges liquid in the individual channels 4 from the nozzles 2 by varying pressures of the individual channels 4 by piezoelectric elements 5 as actuators provided on a nozzle plate 110 (nozzle forming wall) having nozzles. The nozzle plate vibration type is characterized in that droplets can be splashed with smaller force than a general unimorph piezo head (head that discharges liquid by vibrating a surface of a pressure chamber facing a wall portion (nozzle forming wall) with which the nozzle communicates), and can achieve power saving of the actuators.

The liquid discharge head 1 of the present embodiment includes a nozzle plate 110, an individual channel substrate 100, a common channel substrate 120, and a frame unit 140. The nozzle plate 110 has a thin film shape with high compliance, and includes multiple nozzles 2 for discharging liquid, and the piezoelectric elements 5 as electromechanical transducer elements which are annular actuators arranged around the nozzles 2. The individual channel substrate 100 is formed with multiple individual channels 4 communicating with the multiple nozzles 2. The nozzle 2 (vibrating film 112) is formed on one surface of each of the individual channels 4, and openings 4a of the individual channels 4 are arranged on a side facing the one surface. The common channel substrate 120 has a common channel 3 communicating with the multiple individual channels 4.

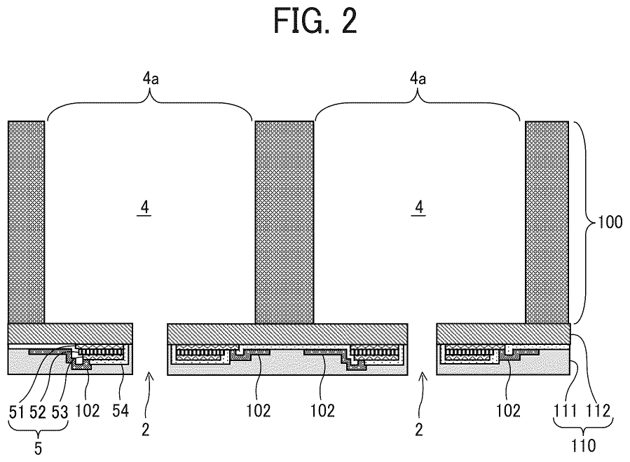

FIG. 2 is an enlarged cross-sectional view illustrating a peripheral configuration of one individual channel 4.

The individual channel substrate 100 is a silicon on insulator (SOI) substrate, and includes a drive circuit and the piezoelectric element 5 on the side on which the vibrating film 112 is formed. The drive circuit is a circuit including a transistor, a resistor, and the like. A wiring 102 includes a wiring portion for applying a drive waveform to a first electrode 51 of the piezoelectric element 5 and a wiring portion for applying a drive waveform to a second electrode 53 of the piezoelectric element 5.

In the nozzle plate 110, multiple nozzles 2 is formed, and a protective film 111 covering the piezoelectric element 5 is provided on the vibrating film 112. A liquid-repellent film may be formed on the nozzle surface side of the protective film 111. In a case where discharge of the liquid is continued, mist generated at the same time as the discharge may adhere to the nozzle surface. If a large amount of mist adheres to the nozzle surface, there is a possibility that the liquid discharged from the nozzle 2 is affected by the liquid adhered to the nozzle surface and deviates from a desired landing position. By forming the liquid-repellent film on the nozzle surface, it is possible to reduce or prevent adhesion of the liquid to the nozzle surface, and it is possible to reduce or prevent influence of the liquid adhered to the nozzle surface on the liquid discharged from the nozzle 2.

The piezoelectric element 5 of the nozzle plate 110 includes the first electrode 51 (also referred to as a lower electrode), a piezoelectric film 52, and the second electrode 53 (also referred to as an upper electrode). The piezoelectric element 5 is covered with an insulating film 54.

In general, lead zirconate titanate (PZT) is widely used as a material of the piezoelectric element to be used as the actuator because of its high piezoelectric characteristics. However, in a case where a piezoelectric film of the piezoelectric element 5 is formed on the nozzle plate 110 on which the drive circuit and the wiring 102 are formed as in the liquid discharge head 1 of the present embodiment, PZT involves a film formation/crystallization temperature of 600° C. or higher. Thus, in a case where PZT is used as the material of the piezoelectric element 5, the drive circuit and the wiring 102 cannot withstand a high temperature. Thus, in the configuration in which the wiring 102 and the drive circuit are formed on the same nozzle plate 110 as the piezoelectric element 5, a piezoelectric material having a lower film formation temperature than PZT is used as the piezoelectric material. A piezoelectric material having a low film formation temperature often has lower piezoelectric characteristics than PZT. However, in the nozzle plate vibration type described above, liquid can be discharged with smaller force than a general unimorph piezo head. Thus, a material having lower piezoelectric characteristics than PZT can be selected. Thus, even a piezoelectric material such as a non-lead material having a low film formation/crystallization temperature but low power can discharge the liquid satisfactorily. Thus, as the piezoelectric element 5 in the present embodiment, a piezoelectric element such as AlN or ScAlN containing aluminum nitride (AlN) can be adopted.

The liquid filled in the liquid discharge head 1 enters the nozzle 2 and forms a meniscus in the nozzle. By applying a predetermined drive waveform (voltage) to each of the electrodes 51 and 53 of the piezoelectric element 5, the piezoelectric film 52 vibrates, and the vibrating film 112 is displaced (vibrated) in a vertical direction in FIG. 2. As a result of the vibrating film 112 being displaced (vibrated), pressure change occurs in the liquid in the individual channel 4, and the liquid is discharged from the nozzle 2.

The vibrating film 112 may be made of at least an insulating material such as SiO₂, SiN, a metal oxide, or a resin. However, in order to increase the displacement, a material having a low Young's modulus is desirable, and considering a difference in linear expansion coefficient from the individual channel substrate 100, SiO₂ (silicon dioxide) having a relatively small difference is most desirable as the material of the vibrating film 112.

The first electrode 51 and the second electrode 53 are desirably metals having low electric resistance and low reactivity, and are desirably metals such as Ir and Mo. As the piezoelectric material constituting the piezoelectric film 52, a piezoelectric material having a film formation temperature of 450° C. or lower is desirable in order not to destroy the drive circuit and the wiring 102. Examples of the piezoelectric material having a film formation temperature of 450° C. or lower include AlN, or ScAlN having a piezoelectric constant higher than that of AlN.

Further, by using ScAlN as the piezoelectric material, the following advantages can also be obtained. In other words, it is possible to improve the piezoelectric characteristics by aligning crystal orientation of the piezoelectric film 52, but an orientation control layer is to be provided between the vibrating film 112 and the first electrode 51 in order to control the orientation. In a case where the piezoelectric material of the piezoelectric film 52 is ScAlN, a lattice constant of the first electrode 51 made of Mo can be made close to ScAlN by using ScAlN also as the orientation control layer. As a result, the crystal orientation of the piezoelectric film 52 is aligned, and the piezoelectric characteristics are improved.

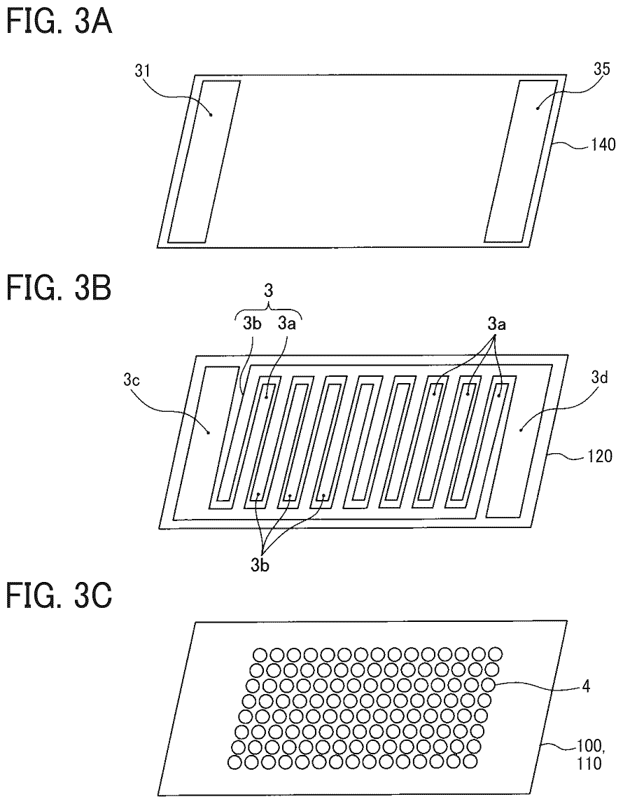

FIG. 3 is an exploded view of the liquid discharge head 1 according to the present embodiment, in which FIG. 3A illustrates the frame unit 140, FIG. 3B illustrates the common channel substrate 120, and FIG. 3C illustrates a drive substrate in which the individual channel substrate 100 and the nozzle plate 110 are integrated.

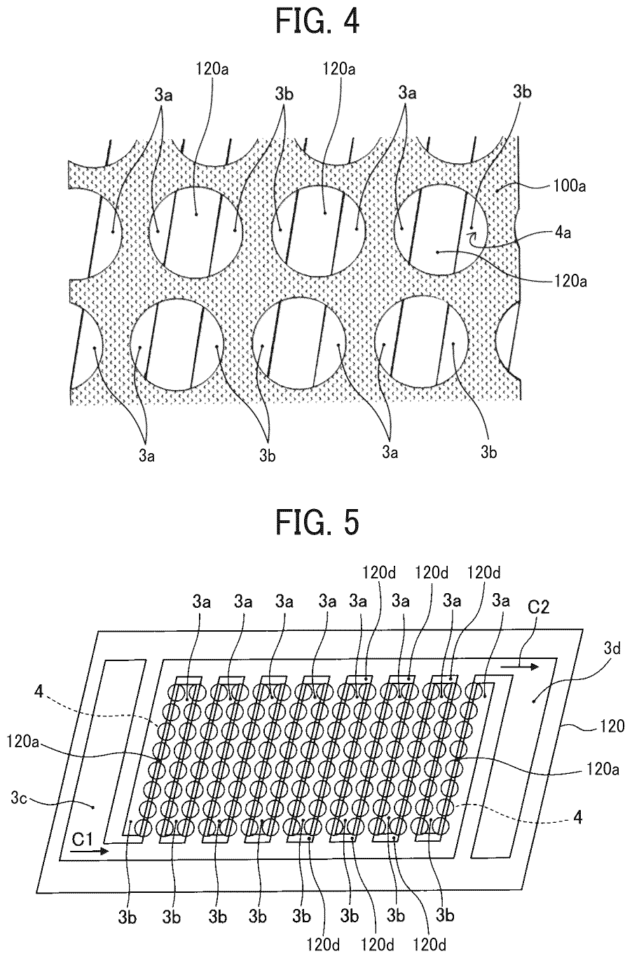

FIG. 4 is an explanatory view of the common channel 3 of the common channel substrate 120 according to the present embodiment as viewed from the individual channel 4 side.

In the individual channel substrate 100, as illustrated in FIG. 3C, multiple individual channels 4 is formed to be arranged in a two-dimensional direction so as to correspond to the multiple nozzles 2 formed in the nozzle plate 110. Specifically, on the nozzle plate 110, multiple nozzle rows (eight rows in the illustrated example) in which the nozzles 2 are linearly arranged along a left-right direction in the drawing is arranged in a vertical direction in the drawing. Thus, as illustrated in FIG. 3, the individual channels 4 formed in the individual channel substrate 100 are also arranged such that multiple (eight in the illustrated example) rows arranged along the left-right direction in the drawing is arranged in the vertical direction in the drawing.

Note that the nozzles between the respective nozzle rows are arranged so that the positions in the nozzle row direction (left-right direction in the drawing) are shifted from each other so that high-density (for example, 600 dpi, 1000 dpi, 1200 dpi, or the like) dots can be formed in a single pass. Accordingly, as illustrated in FIG. 3C, the individual channels 4 are also arranged such that the positions in the left-right direction in the drawing are shifted from each other between the rows.

In addition, an example has been described where a cross-sectional shape of the individual channel 4 of the present embodiment, parallel to a substrate surface direction is a circular shape, but the cross-sectional shape may be another shape such as an elliptical columnar shape or a polygonal columnar shape. Furthermore, the cross-sectional shape does not have to be uniform in a substrate thickness direction.

As illustrated in FIG. 4, the openings 4a of the individual channels 4 are opened on an upper surface (a surface on the common channel 3 side) of the individual channel substrate 100, and the common channels 3 formed in the common channel substrate 120 are arranged so as to face the openings 4a of the individual channels 4.

In the present embodiment, the opening 4a of each of the individual channels 4 faces the two common channel portions 3a and 3b partitioned from each other by a common channel partition 120a. In other words, the opening 4a of each of the individual channels 4 is divided into two opening portions by the common channel partition 120a. In the present embodiment, one common channel portion 3a facing the opening 4a of the individual channel 4 is a supply common channel portion for supplying liquid to the individual channel 4, and the other common channel portion 3b facing the opening 4a of the individual channel 4 is a discharge common channel portion for discharging liquid from the individual channel 4.

As illustrated in FIG. 3B, the common channels 3 formed in the common channel substrate 120 according to the present embodiment are configured such that the supply common channel portions 3a and the discharge common channel portions 3b have a comb-teeth shape, and the comb-teeth portions are fitted to each other.

Specifically, as illustrated in FIG. 5, the eight individual channels 4 corresponding to the eight nozzles adjacent to each other across the nozzle rows are connected to the two common channel portions 3a and 3b partitioned by the common channel partitions 120a. The common channel partitions 120a are arranged side by side in the nozzle row direction (left-right direction in the drawing). Ends of the common channel partitions 120a in the vertical direction in the drawing are connected to each other by partitions 120d. With such a configuration, one of spaces partitioned by the common channel partitions 120a and the partition 120d forms the supply common channel portion 3a, and the other space forms the discharge common channel portion 3b.

The common channel substrate 120 includes a high-precision processed component, and in the present embodiment, is formed by performing a semiconductor process such as photolithography or silicon deep etching (DRIE processing), or a microelectromechanical system (MEMS) process on a silicon (Si) substrate (Si wafer). A wetted film (TaOₓ, HfOₓ, or the like) having elution resistance to liquid is formed on wall surfaces of the channels (the common channel portions 3a and 3b, a channel inlet portion 3c, and a channel outlet portion 3d) formed in the common channel substrate 120. Note that the common channel substrate 120 is not limited thereto, and for example, a substrate obtained by processing a stainless-steel plate (SUS plate) or a glass substrate by high-precision grinding processing, high-precision pressing processing, sandblasting, or the like, may be used. In addition, a substrate manufactured by Ni electroforming using photolithography similar to the semiconductor process may be used.

The frame unit 140 illustrated in FIG. 3A is provided on an upper surface of the common channel substrate 120 (the surface opposite to the individual channel substrate 100). Liquid stored in an external liquid storage is supplied to the liquid discharge head 1 through a liquid supply port of the frame unit 140. The liquid supplied from the liquid supply port is supplied from a supplied liquid storage chamber 31 in the frame unit 140 to the channel inlet portion 3c arranged on one end side (one end side in a nozzle row direction, left side in the drawing) of the common channel substrate 120 through a supply communication path 32. Thereafter, as indicated by an arrow C1 in FIG. 5, the liquid supplied to the channel inlet portion 3c flows along the upper surface of the individual channel substrate 100 through the supply common channel portion 3a in a comb-teeth shape, and is supplied to each individual channel 4 from an opening portion (supply port) on a side facing the supply common channel portion 3a among the openings 4a of the individual channels 4 of the individual channel substrate 100.

Among the liquid in the individual channels 4, liquid that is not discharged from the nozzles 2 is discharged to the discharge common channel portion 3b from the opening portion (discharge port) of the openings 4a of the respective individual channels 4 on the side facing the discharge common channel portion 3b. The liquid discharged from each of the individual channels 4 flows along the upper surface of the individual channel substrate 100 through the discharge common channel portion 3b, and is discharged from the channel outlet portion 3d arranged on the other end side (other end side in the nozzle row direction, right side in the drawing) of the common channel substrate 120 to a discharged liquid storage chamber 35 in the frame unit 140 through a discharge communication path 34 in a direction indicated by arrow C2. The liquid discharged to the discharged liquid storage chamber 35 is returned from the liquid discharge port of the frame unit 140 to an external ink storage unit via an external pump, or the like. In other words, the liquid discharge head 1 of the present embodiment is a liquid discharge head of a liquid circulation type.

According to the liquid discharge head of the liquid circulation type, it is possible to circulate the liquid in the common channel 3 and the individual channels 4. As a result, air bubbles present in the channels in the liquid discharge head 1 such as the common channel 3 and the individual channels 4 can be removed, or settling of a liquid component in the channels in the liquid discharge head 1 can be reduced or prevented in the case of using liquid having a component that is likely to settle. However, the present disclosure is not limited to such a liquid discharge head of a liquid circulation type.

In the case of the liquid discharge head of the liquid circulation type, a depth of the individual channel 4 (dimension in the thickness direction of the individual channel substrate) is preferably, for example, 50 μm or more and 1000 μm or less. In a case where the depth of the individual channels 4 is shallower, liquid flows to the vicinity of the nozzles during liquid circulation in the individual channels. Thus, effects by liquid circulation such as reduction or prevention of liquid thickening in the nozzles 2 or in the vicinity of the nozzles 2, reduction or prevention of settling of a solid component in the liquid, and discharge of air bubbles in the liquid are enhanced. However, there arises a problem that the individual channel substrate 100 is easily cracked during processing.

How to arrange the channel inlet portion 3c and the channel outlet portion 3d (the supplied liquid storage chamber 31 and the discharged liquid storage chamber 35) with respect to the supply common channel portion 3a and the discharge common channel portion 3b can be appropriately set. In the present embodiment, as illustrated in FIG. 5, the supply common channel portion 3a and the discharge common channel portion 3b are arranged near the ends opposite to each other in the nozzle row direction (the left-right direction in the drawing). However, for example, the supply common channel portion 3a and the discharge common channel portion 3b may be arranged near the ends on the same side in the nozzle row direction.

According to the present embodiment, it is possible to create flow for allowing liquid to flow into the openings 4a of the individual channels 4 from the supply common channel portion 3a and flow for allowing liquid to flow out to the discharge common channel portion 3b, and it is possible to create flow for exchanging liquid in the individual channels 4. Thus, movement of the liquid in the individual channels 4 can be made active, air bubbles in the individual channels 4 can be easily moved and discharged from the individual channels 4, and occurrence of a discharge failure can be reduced or prevented.

According to the present embodiment, the common channel 3 formed in the common channel substrate 120 is divided into multiple (two in the present embodiment) common channel portions 3a and 3b by the common channel partitions 120a. Thus, the number of the individual channels 4 connected to each of the multiple common channel portions 3a and 3b is smaller than that in the configuration in the related art in which all the individual channels 4 are connected to a single common channel. Thus, in each of the individual channels 4, the number of the surrounding individual channels 4 connected to the same common channel portions 3a and 3b is reduced, and crosstalk that causes a discharge failure of the nozzle 2 of each of the individual channels 4 is reduced or prevented.

Describing crosstalk, in a case where a pressure is applied to the liquid in the individual channels 4 by vibrating the vibrating film 112 by the piezoelectric elements 5 of the nozzle plate 110, the pressure becomes force for discharging the liquid from the nozzles 2, but part of the pressure escapes from the openings 4a of the individual channels 4 to the common channel side. The released pressure (crosstalk pressure) is propagated to the surrounding individual channels 4 through the common channel as a pressure wave (pressure fluctuation) causing crosstalk or inertial flow causing crosstalk. In other words, a pressure wave and inertial flow from the individual channels 4 existing around the individual channels 4 are propagated through the common channel 3, thereby causing crosstalk that causes a discharge failure of the nozzles 2 of the individual channels 4. As a result of the number of the surrounding individual channels 4 connected to the same common channel portions 3a and 3b being reduced as in the present embodiment, influence of the pressure wave and the inertial flow from the surrounding individual channels 4 propagated to each individual channel 4 is reduced, and thus crosstalk is reduced or prevented.

In the present embodiment, the number of the individual channels 4 connected to the same common channel portions 3a and 3b can be appropriately set, and the arrangement, shape, and the like, of each of the common channel portions 3a and 3b are appropriately determined accordingly.

As the number of the individual channels 4 connected to the same common channel portions 3a and 3b is smaller, crosstalk can be reduced or prevented.

Here, in order to reduce the crosstalk, it is preferable to provide a damper member that reduces a crosstalk pressure of the liquid in the common channel 3. However, in the liquid discharge head in the related art, the damper member is arranged between each of the individual channels and the common channel, and thus, due to the damper member space, the liquid discharge head size increases. In the present embodiment, a damper liquid chamber (or a damper chamber) is provided to reduce or prevent crosstalk without increasing the size of the liquid discharge head.

Specifically, in general, in a type in which liquid is discharged by vibrating a surface side of pressure chambers (corresponding to the individual channels) facing a nozzle forming wall (nozzle plate), in a case where the nozzle plate is displaced (vibrated) when pressure fluctuation is caused in the liquid in the pressure chambers by vibration of the surfaces, appropriate liquid discharge from the nozzles becomes difficult, and liquid discharge performance (discharge deflection, or the like) is affected. Thus, in this type, the compliance of the nozzle plate is designed as small as possible.

On the other hand, in the nozzle plate vibration type including the piezoelectric elements 5 as actuators in the nozzle plate 110, the nozzle plate 110 is greatly displaced by driving the piezoelectric elements 5 in order to cause pressure fluctuation in the liquid in the individual channels. Thus, in the nozzle plate vibration type, a nozzle plate having high compliance is used as compared with the case of the type of vibrating the surface side of the pressure chambers facing the nozzle plate (nozzle forming wall). Specifically, in order to design that achieves high compliance, the thickness of the nozzle plate is designed to be as thin as about several μm, or the nozzle plate is formed using a material having high compliance.

Such a nozzle plate 110 having high compliance can exhibit a function as a damper member, so that it is possible to reduce or prevent crosstalk by using the existing nozzle plate 110 as a damper member without arranging a new damper member separate from the nozzle plate. Thus, in the present embodiment, a configuration is employed in which damper liquid chambers facing the nozzle plate 110 are provided separately from the individual channels 4, and the damper liquid chambers communicate with the common channel 3. According to this, the crosstalk pressure of the liquid generated in the individual channels 4 is propagated to the damper liquid chambers via the common channel 3, whereby the nozzle plate with high compliance facing the damper liquid chambers is deformed to absorb the crosstalk pressure, and the pressure fluctuation due to the crosstalk pressure generated in the common channel 3 can be reduced.

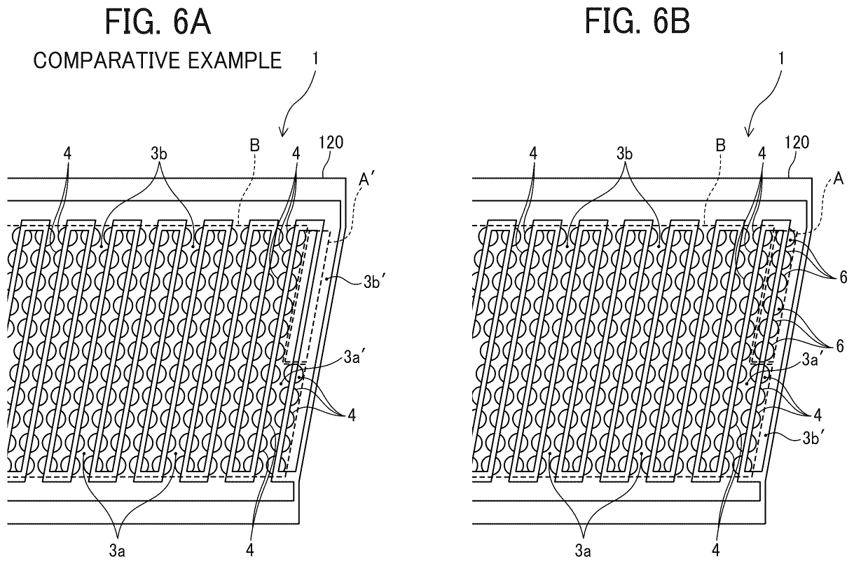

FIG. 6A is an explanatory view illustrating an example (comparative example) of a liquid discharge head not provided with damper liquid chambers, and FIG. 6B is an explanatory view illustrating an example of a liquid discharge head 1 according to the present embodiment provided with damper liquid chambers.

FIGS. 6A and 6B correspond to the cross section of the reference sign E-E′ in FIG. 1, and the nozzle rows in which the nozzles 2 are linearly arranged are arranged in 11 rows in the vertical direction in the drawing.

In the supply common channel portions of the common channel 3, there may be supply common channel portions 3a and 3a′ having different numbers of communicating individual channels as illustrated in FIG. 6A for various purposes, restrictions, and the like. For example, in the comparative example of FIG. 6A, the number of the individual channels 4 communicating with the supply common channel portion 3a′ located on one end side (the rightmost side in the drawing) in the nozzle row direction is 16, whereas the number of the individual channels 4 communicating with the other supply common channel portion 3a is 22.

In other words, in the comparative example illustrated in FIG. 6A, there is an individual channel missing region A′ in which the individual channels 4 are missing, and thus, the number (16) of the individual channels 4 communicating with the supply common channel portion 3a′ is smaller than the number (22) of the individual channels 4 communicating with the other supply common channel portion 3a.

Similarly, among the discharge common channel portions of the common channel 3, there may be supply common channel portions 3b and 3b′ having different numbers of communicating individual channels as illustrated in FIG. 6A for various purposes, restrictions, and the like. For example, in the comparative example of FIG. 6A, the number of the individual channels 4 communicating with the discharge common channel portion 3b′ located on one end side (rightmost side in the drawing) in the nozzle row direction is 5, whereas the number of the individual channels 4 communicating with the other discharge common channel portion 3 b is 22.

In the present embodiment, as illustrated in FIG. 6B, the damper liquid chambers 6 are formed in a portion of the individual channel substrate 100 corresponding to the missing region A where the individual channels 4 are missing. The inner wall surface of the damper liquid chambers 6 on the nozzle plate side is formed by the nozzle plate 110 similarly to the individual channels 4. Thus, the damper liquid chambers 6 have a structure facing the nozzle plate 110. The damper liquid chambers 6 are configured to communicate with the supply common channel portion 3a′ and the discharge common channel portion 3b′ similarly to the individual channels 4.

With such a configuration, the crosstalk pressure of the liquid generated in the individual channels 4 communicating with the supply common channel portion 3a′ and the discharge common channel portion 3b′ with which the damper liquid chambers 6 communicate is propagated to the damper liquid chambers 6 via the supply common channel portion 3a′ and the discharge common channel portion 3b′. As a result, it is considered that the nozzle plate 110 of the damper liquid chambers 6 is displaced to absorb the crosstalk pressure, and the pressure fluctuation due to the crosstalk pressure generated in the supply common channel portion 3a′ and the discharge common channel portion 3b′ is reduced. It is therefore possible to reduce or prevent defects such as a discharge failure caused by the crosstalk pressure generated in the nozzles 2 of these individual channels 4.

In particular, in the present embodiment, the damper liquid chambers 6 communicate with the supply common channel portions 3a′ for which the number of communicating individual channels 4 is smaller than the number (22) of the individual channels 4 communicating with the other supply common channel portion 3a.

As a result, in the present embodiment, the damper liquid chambers 6 behave as if they were individual channels, so that a state of the supply common channel portion 3a′ with which only 16 individual channels 4 communicate can be brought close to a state of the other supply common channel portion 3a with which 22 individual channels 4 communicate. As a result, a discharge condition at the time of discharging the liquid from the nozzles 2 of the individual channels 4 communicating with the supply common channel portion 3a′ can be brought close to a discharge condition at the time of discharging the liquid from the nozzles 2 of the individual channels 4 communicating with the other supply common channel portion 3a.

The discharge condition mentioned herein is a condition that the discharge state of the liquid discharged from the nozzles 2 of the individual channels is made different between the supply common channel portions due to a difference in the number of individual channels communicating with each supply common channel portion. Specific examples thereof include liquid flow (such as a flow velocity and a flow rate of the liquid, a fluid resistance value, and the like) in the supply common channel portion caused by a difference in the number of communicating individual channels, a propagation state of a crosstalk pressure, and a difference in compliance of a nozzle plate portion facing each of the individual channels caused by a difference in the number of communicating individual channels.

As described above, the discharge conditions of the supply common channel portions 3a′ and 3a for which the number of communicating individual channels 4 is different from each other approach each other, so that it is possible to reduce the difference in the liquid discharge state between the supply common channel portion 3a′ and the other supply common channel portion 3a. As a result, the liquid discharge state of the entire liquid discharge head can be made uniform.

In the present embodiment, similarly in the discharge common channel portions 3b′ and 3b, the damper liquid chambers 6 communicate with the discharge common channel portion 3b′ for which the number of communicating individual channels 4 is smaller than the number (22) of the individual channels 4 communicating with the other discharge common channel portion 3b. As a result, in the present embodiment, the damper liquid chambers 6 behave as if they were individual channels, so that a state of the discharge common channel portion 3b′ with which only five individual channels 4 communicate can be brought close to a state of the other discharge common channel portion 3b with which 22 individual channels 4 communicate. Thus, a discharge condition at the time of discharging the liquid from the nozzles 2 of the individual channels 4 communicating with the discharge common channel portion 3b′ can be brought close to a discharge condition at the time of discharging the liquid from the nozzles 2 of the individual channels 4 communicating with the other discharge common channel portion 3b. As a result, the liquid discharge state of the entire liquid discharge head can be made uniform.

In addition, the damper liquid chambers 6 of the present embodiment have the same configuration as the individual channels 4. Specifically, the damper liquid chambers 6 are formed on the same individual channel substrate 100 in the same size by the same manufacturing method as the individual channels 4. As a result, the damper liquid chambers 6 can behave substantially similarly to the individual channels, and the states (discharge conditions) of the supply common channel portion 3a′ and the discharge common channel portion 3b′ can be further brought closer to the states (discharge conditions) of the other supply common channel portion 3a and the other discharge common channel portion 3b. Thus, the liquid discharge state of the entire liquid discharge head can be made further uniform.

In particular, in the present embodiment, the damper liquid chambers 6 are provided such that the total number of the damper liquid chambers 6 and the individual channels 4 communicating with the supply common channel portion 3a′ is 22. As a result, the total number (22) of the damper liquid chambers 6 and the individual channels 4 communicating with the supply common channel portion 3a′ is equal to the number (22) of the individual channels 4 communicating with the other supply common channel portion 3a. Thus, the state (discharge condition) of the supply common channel portion 3a′ is substantially the same as the state (discharge condition) of the other supply common channel portion 3a, and the liquid discharge state of the entire liquid discharge head can be made further uniform.

Although the nozzles 2 are open in the nozzle plate portion facing the individual channels 4, openings may be formed or do not have to be formed in the nozzle plate portion facing the damper liquid chambers 6. However, in a case where the openings are formed in the nozzle plate portion facing the damper liquid chambers 6, the compliance of the nozzle plate portion is increased, so that a higher damper effect can be obtained. In particular, by configuring the openings of the damper liquid chambers 6 to form a meniscus similar to that of the nozzles 2, a damper effect by change in the meniscus is also exhibited, and as a result, a higher damper effect can be obtained. However, depending on the design of the nozzle plate 110, the overall compliance may become higher in a case where the openings are not formed in the damper liquid chambers 6 than in a case where the meniscus is formed in the openings of the damper liquid chambers 6.

In addition, as maintenance operation of the liquid discharge head 1, purge operation (pressure purge or suction purge) for forcibly discharging the liquid in the individual channels 4 from the nozzles 2 may be performed to remove air bubbles and foreign matters in the individual channels 4. In this case, it is preferable to form openings in the damper liquid chambers 6 in order to remove air bubbles and foreign matters in the damper liquid chambers 6 together.

As described above, whether or not to form openings in the damper liquid chambers 6 is appropriately selected in consideration of various conditions.

In a case where openings are formed in the nozzle plate portion facing the damper liquid chambers 6, the structure of the openings may be the same as that of the nozzles 2 or may be a structure different from that of the nozzles 2. If the openings of the damper liquid chambers 6 have the same structure as the nozzles 2, the openings can be formed in the damper liquid chambers 6 in the same process as the process of forming the nozzles 2 in the nozzle plate 110, and the manufacturing process can be simplified.

On the other hand, in a case where the structure of the openings of the damper liquid chambers 6 is different from the structure of the nozzles 2, the structure of the openings is not limited to the structure of the nozzles 2, and thus, for example, the structure of the openings can be designed so as to obtain a higher damper effect. In this case, it is preferable to design so that the total compliance of the meniscus formed in the openings and the nozzle plate portion facing the damper liquid chambers 6 becomes maximum.

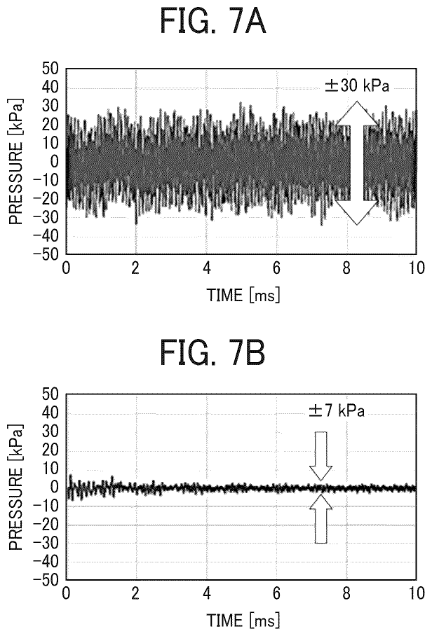

FIGS. 7A and 7B are graphs indicating results of a simulation (numerical calculation) performed to confirm the damper effect of the nozzle plate 110.

FIGS. 7A and 7B are graphs indicating results of numerical calculation of pressure fluctuation in the common channel 3 assuming the case of discharging liquid from all the nozzles of the liquid discharge head 1 of the present embodiment. Specifically, it is obtained by numerically calculating the pressure fluctuation generated in the common channel 3 when the pressure fluctuation is generated assuming the time of liquid discharge in all the individual channels.

The graph indicated in FIG. 7A is results of the numerical calculation in a case where a compliance component of the nozzle plate 110 is excluded from the calculation (in a case where the compliance of the nozzle plate 110 is 0).

On the other hand, the graph indicated in FIG. 7B indicates results of the numerical calculation in a case where the calculation is performed in consideration of the compliance component of the nozzle plate 110 of the present embodiment. In other words, the graph indicated in FIG. 7B indicates results of the simulation in the case of using a nozzle plate with high compliance that is to be used in the nozzle plate vibration type.

Comparing the graphs of FIGS. 7A and 7B, in the example of FIG. 7A, the compliance of the nozzle plate 110 was small (the compliance was 0), and the pressure fluctuation in the common channel 3 was approximately ±30 kPa. On the other hand, in the example of FIG. 7B in which the compliance of the nozzle plate 110 is high, the pressure fluctuation in the common channel 3 is about ±7 kPa, and can be reduced to about 23% of the example of FIG. 7A. It is therefore possible to confirm the damper effect of attenuating the pressure fluctuation in the common channel 3 by the nozzle plate 110 having high compliance.

Note that the larger the number of individual channels communicating with the common channel 3, more specifically, the larger the number of spaces (the individual channels 4 and the damper liquid chambers 6) facing the nozzle plate 110 communicating with the common channel 3, the higher the damper effect. This is considered to be because the increase in space facing the nozzle plate 110 reduces the area of the substrate portion of the individual channel substrate 100 facing the nozzle plate, thereby increasing the overall compliance of the nozzle plate 110.

### First Modification

Next, description will be given of a modification (the present modification is hereinafter referred to as a “first modification”) of the liquid discharge head according to the above-described embodiment.

In the embodiment described above, the damper liquid chambers 6 are provided along part of an outer peripheral portion of an individual channel region B (see FIG. 6) where all the individual channels 4 of the liquid discharge head 1 are arranged. On the other hand, the first modification is an example in which the damper liquid chambers 6 are provided along the entire region (entire periphery) of the outer peripheral portion of the individual channel region B. The basic configuration of the liquid discharge head 1 of the first modification is the same as that of the above-described embodiment, and thus, redundant description will be appropriately omitted.

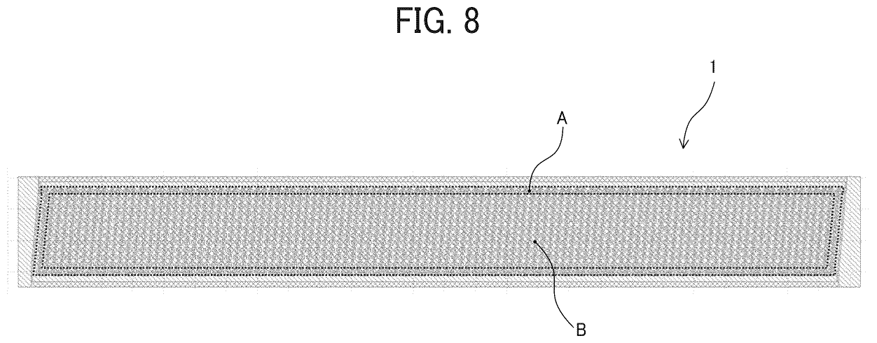

FIG. 8 is an explanatory view illustrating a schematic configuration of a liquid discharge head according to the first modification.

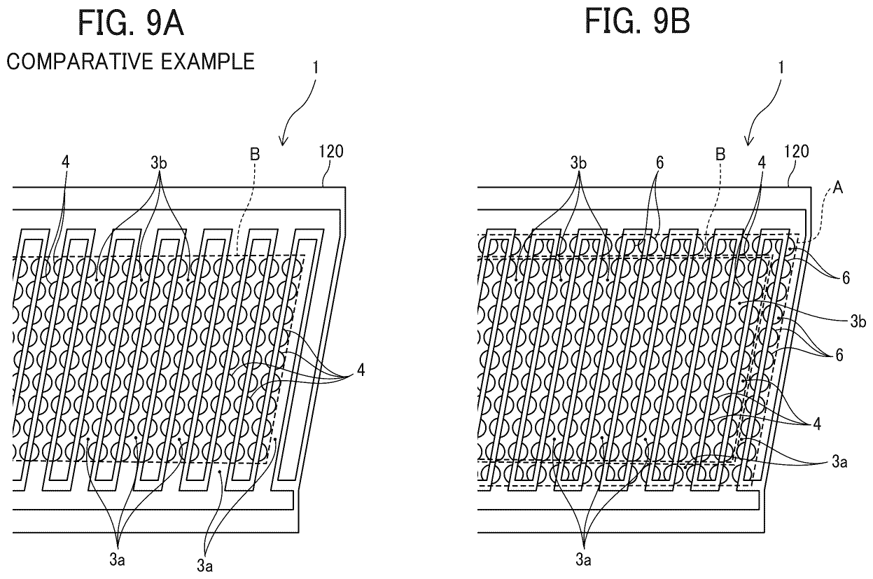

FIG. 9A is an explanatory view illustrating part of the liquid discharge head not provided with the damper liquid chambers, and FIG. 9B is an explanatory view illustrating part of the liquid discharge head 1 according to the first modification provided with the damper liquid chambers.

FIGS. 9A and 9B correspond to the cross section of the reference sign E-E′ in FIG. 1, and the nozzle rows in which the nozzles 2 are linearly arranged are arranged in eight rows in the vertical direction in the drawing.

In the first modification, as illustrated in FIG. 9B, the damper liquid chambers 6 are provided along the entire region (entire periphery) of the outer peripheral portion of the individual channel region B where all the individual channels 4 of the liquid discharge head 1 are arranged. In other words, as illustrated in FIG. 8, the individual channel region B is surrounded by a damper liquid chamber region A in which the damper liquid chambers 6 are arranged.

In the first modification, the damper liquid chambers 6 communicate with both the supply common channel portion 3a and the discharge common channel portion 3b. It is therefore possible to reduce pressure fluctuation due to the crosstalk pressure generated in any of the supply common channel portion 3a and the discharge common channel portion 3b.

Further, as in the first modification, by providing the damper liquid chambers 6 along at least part of the outer peripheral portion of the individual channel region B, the liquid discharge state from the nozzles 2 of the individual channels 4 (the individual channels 4 located in the outer peripheral portion of the individual channel region B) adjacent to the damper liquid chambers 6 can be brought close to the liquid discharge state from the nozzles 2 of the individual channels 4 (the individual channels 4 surrounded by eight individual channels) located in the inner portion of the individual channel region B.

Specifically, the nozzle plate portion facing the individual channels 4 located in the inner portion of the individual channel region B has relatively high compliance because the surrounding nozzle plate portion faces the eight individual channels, and the area facing the substrate portion of the individual channel substrate 100 is small. On the other hand, the nozzle plate portion facing the individual channels 4 located in the outer peripheral portion of the individual channel region B has relatively low compliance because the individual channels 4 do not exist on the outer side of the individual channel region B, and the substrate portion of the individual channel substrate 100 faces the nozzle plate portion on the outer side. Such a difference in compliance becomes a difference in displacement or vibration behavior of the nozzle plate by driving of the piezoelectric elements 5, and causes a difference in the liquid discharge state from the nozzles 2.

As in the first modification, by providing the damper liquid chambers 6 along at least part of the outer peripheral portion of the individual channel region B, the damper liquid chambers 6 behave as if they were individual channels, so that the compliance of the nozzle plate portion facing the individual channels 4 located in the outer peripheral portion of the individual channel region B can be enhanced. As a result, the compliance of the nozzle plate portion facing the individual channels 4 located in the outer peripheral portion of the individual channel region B can be brought close to the compliance of the nozzle plate portion facing the individual channels 4 located in the inner portion of the individual channel region B. As a result, it is possible to bring the behavior of displacement or vibration of the nozzle plate by driving of the piezoelectric elements 5 close between the individual channels 4 located at the outer peripheral portion of the individual channel region B and the individual channels 4 located in the inner portion of the individual channel region B, and to reduce or prevent a difference in the liquid discharge state from the nozzles 2.

In particular, in the first modification, the damper liquid chambers 6 are provided along the entire region (entire periphery) of the outer peripheral portion of the individual channel region B, and thus, all the individual channels 4 located in the outer peripheral portion of the individual channel region B can be brought close to the liquid discharge state from the nozzles 2 of the individual channels 4 located in the inner portion of the individual channel region B. Thus, the liquid discharge state of the entire liquid discharge head can be made uniform.

In the first modification, the damper liquid chambers 6 are provided for one circumference along the entire region (entire periphery) of the outer peripheral portion of the individual channel region B. However, the damper liquid chambers 6 may be provided for two or more circumferences. In this case, a higher damper effect can be obtained, or the liquid discharge state can be made further uniform, but there is also a disadvantage of causing increase in size of the liquid discharge head. From this viewpoint, it is preferable to provide the minimum number of damper liquid chambers 6 such that the total numbers of the damper liquid chambers 6 and the individual channels 4 communicating with all the supply common channel portions 3a become the same. Similarly, it is preferable to provide the minimum number of damper liquid chambers 6 such that the total numbers of the damper liquid chambers 6 and the individual channels 4 communicating with all the discharge common channel portions 3b become the same.

### Second Modification

Next, description will be given of another modification (the present modification is hereinafter referred to as a “second modification”) of the liquid discharge head according to the above-described embodiment.

In the liquid discharge head 1 of the second modification, the damper liquid chambers 6 are provided in the inner portion of the individual channel region B. The basic configuration of the liquid discharge head 1 of the second modification is also the same as that of the above-described embodiment, and thus, redundant description will be appropriately omitted.

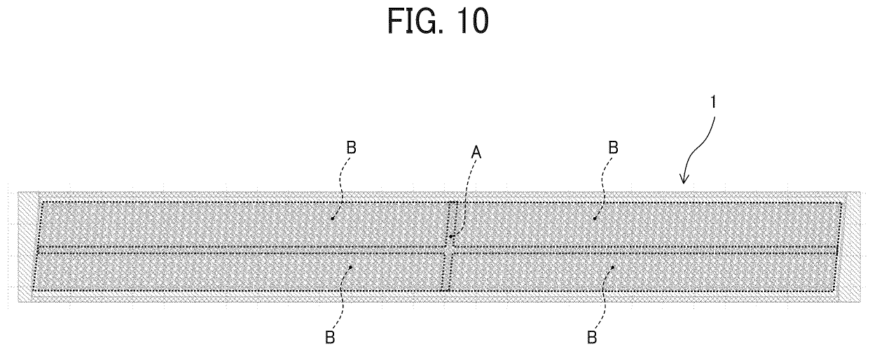

FIG. 10 is an explanatory view illustrating a schematic configuration of the liquid discharge head according to the second modification.

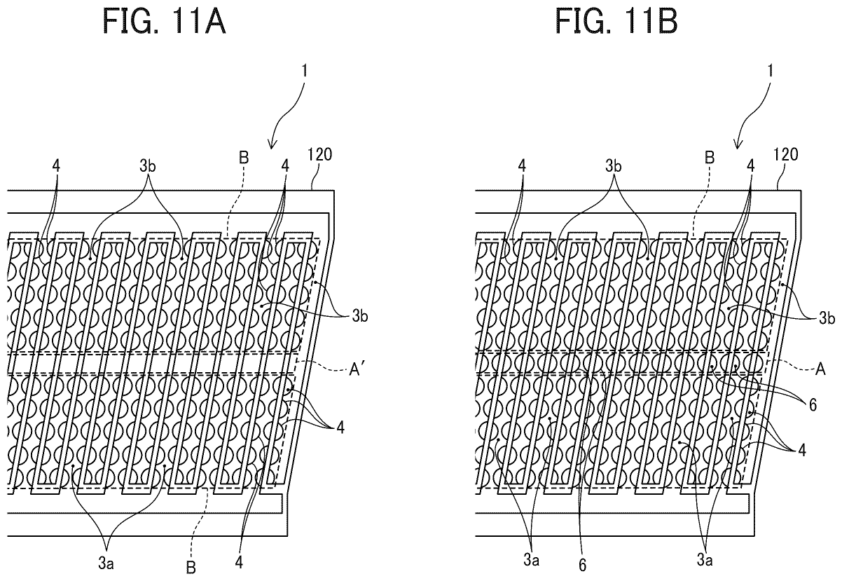

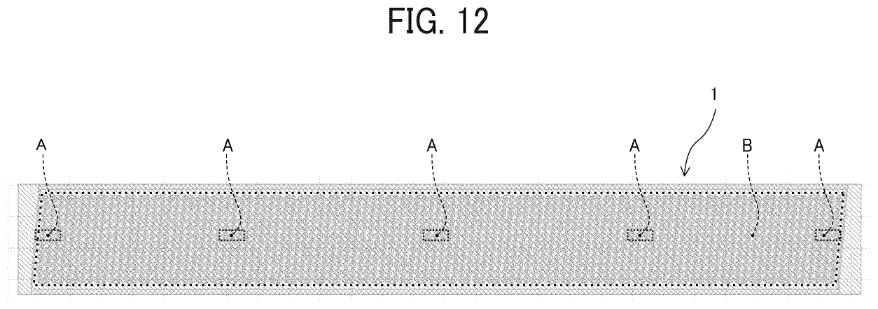

FIG. 11A is an explanatory view illustrating part of the liquid discharge head not provided with the damper liquid chambers, and FIG. 11B is an explanatory view illustrating part of the liquid discharge head 1 according to the second modification provided with the damper liquid chambers.

FIGS. 11A and 11B correspond to the cross section of the reference sign E-E′ in FIG. 1, and the nozzle rows in which the nozzles 2 are linearly arranged are arranged in 11 rows in the vertical direction in the drawing.

Due to the arrangement and wiring of the drive circuit, other restrictions, and the like, as illustrated in FIG. 11A, there may be an individual channel missing region A′ where the individual channels 4 are missing in the inner portion of the individual channel region B where all the individual channels 4 of the liquid discharge head 1 are arranged. Specifically, in the example illustrated in FIG. 11A, the individual channel missing region A′ exists so as to cross the center in the left-right direction (nozzle row direction) in the drawing and cross the center in the vertical direction in the drawing.

In the present second modification, as illustrated in FIG. 11B, the damper liquid chambers 6 are formed in a portion of the individual channel substrate 100 corresponding to the missing region A where the individual channels 4 are missing. As a result, the damper liquid chambers 6 are provided in the inner portion of the individual channel region B. Even with such a configuration, the nozzle plate 110 of the damper liquid chambers 6 is displaced to absorb the crosstalk pressure, and pressure fluctuation due to the crosstalk pressure generated in the supply common channel portion 3a and the discharge common channel portion 3b is reduced, so that it is possible to reduce or prevent defects such as a discharge failure caused by the crosstalk pressure.

In particular, also in the second modification, the damper liquid chambers 6 are provided such that the total numbers of the damper liquid chambers 6 and the individual channels 4 communicating with all the supply common channel portions 3a become the same. The damper liquid chambers 6 are provided such that the total numbers of the damper liquid chambers 6 and the individual channels 4 communicating with all the discharge common channel portions 3b become the same. Thus, the states (discharge conditions) of all the supply common channel portions 3a are substantially the same, and the liquid discharge state of the entire liquid discharge head can be made uniform.

In the present second modification, as illustrated in FIG. 10, the damper liquid chambers 6 are arranged in the missing region A which vertically crosses the center in the left-right direction (nozzle row direction) in the drawing and horizontally crosses the center in the vertical direction in the drawing, but the present disclosure is not limited thereto. For example, as a configuration in which the damper liquid chambers 6 are provided in the inner portion of the individual channel region B where all the individual channels 4 are arranged, the damper liquid chambers 6 may be dispersedly arranged in the inner portion of the individual channel region B. For example, as illustrated in FIG. 12, in a case where multiple missing regions A in which the individual channels 4 are missing is dispersedly present in the inner portion of the individual channel region B, the damper liquid chambers 6 may be provided in these missing regions A.

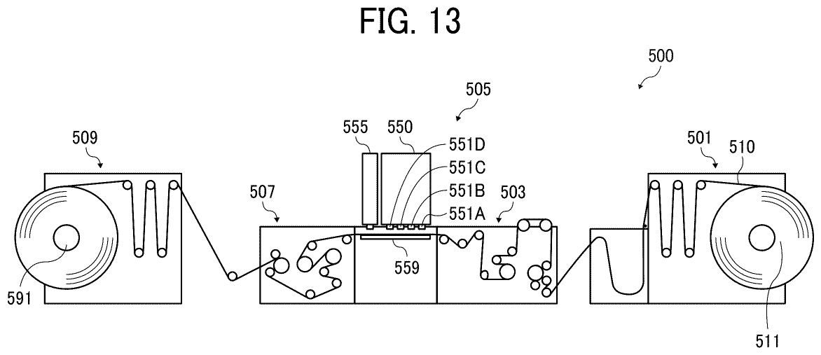

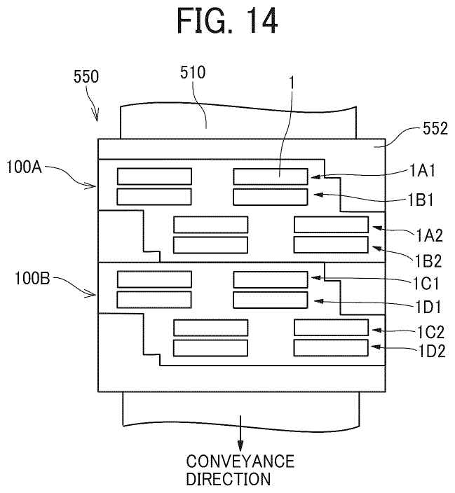

Next, an example of a liquid discharge apparatus according to an embodiment of the present disclosure will be described with reference to FIGS. 13 and 14.

FIG. 13 is an explanatory schematic view of a printing apparatus that is an inkjet recording apparatus that is an image forming apparatus as the liquid discharge apparatus in the present embodiment.

FIG. 14 is an explanatory plan view of an example of a head unit of the printing apparatus of the present embodiment.

A printing apparatus 500, which is a liquid discharge apparatus, includes a feeder 501 that carries in a continuous medium 510, and a guide conveyor 503 that guides and conveys the continuous medium 510 carried in from the feeder 501 to a printing device 505. The printing apparatus 500 also includes the printing device 505, a dryer 507, and a carrier 509. The printing device 505 discharges liquid onto the continuous medium 510 to form an image. The dryer 507 dries the continuous medium 510. The carrier 509 ejects the continuous medium 510.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509. In the printing device 505, the continuous medium 510 is conveyed opposite the head unit 550 on a conveyance guide 559, and an image is printed by liquid discharged from the head unit 550.

In the printing apparatus 500, the head unit 550 includes the two head modules 100A and 100B on a common base 552.

In a case where an arrangement direction of liquid discharge heads 1 in a direction orthogonal to a conveyance direction of the head modules 100A and 100B is defined as a head arrangement direction, liquid of the same color is discharged in head rows 1A1 and 1A2 of the head module 100A. Similarly, head rows 1B1 and 1B2 of the head module 100A form a set, head rows 1C1 and 1C2 of the head module 100B form a set, and head rows 1D1 and 1D2 form a set, and liquid of desired colors is discharged.

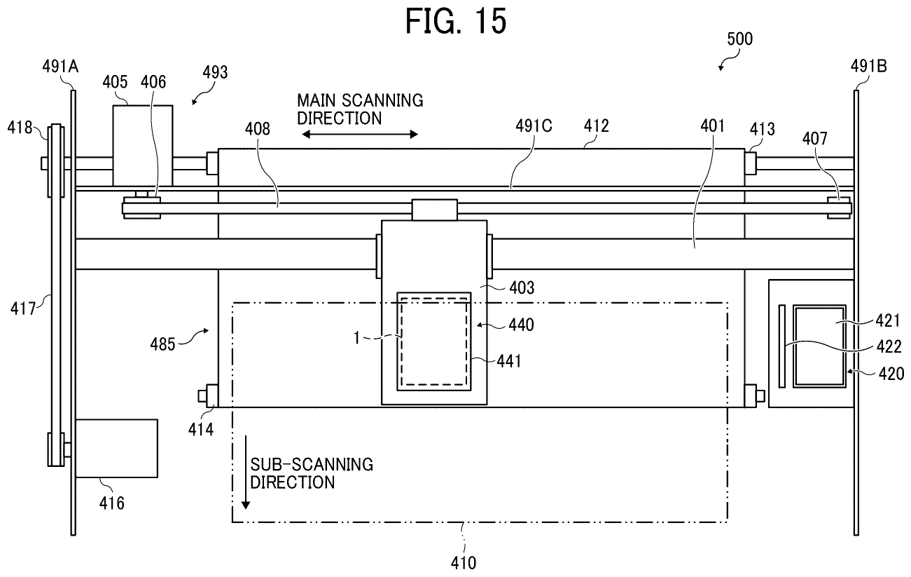

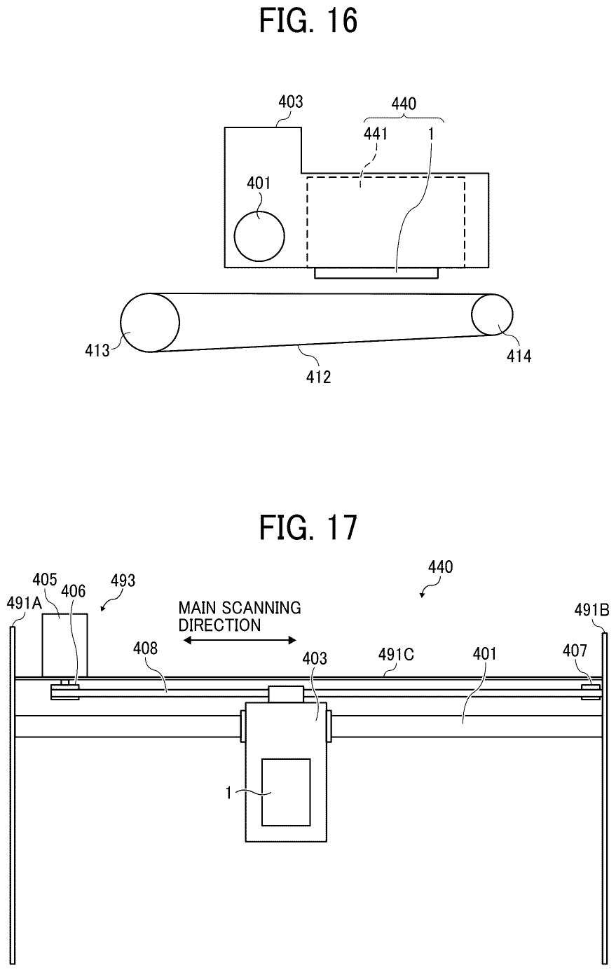

Next, another example of a printing apparatus as a liquid discharge apparatus according to an embodiment of the present disclosure will be described with reference to FIGS. 15 and 16.

FIG. 15 is an explanatory plan view of a main portion of the printing apparatus of the present example.

FIG. 16 is an explanatory side view of the main portion of the printing apparatus of the present example.

The printing apparatus 500 of the present example is a serial type apparatus, and a carriage 403 reciprocates in a main scanning direction by a main scanning movement mechanism 493. The main scanning movement mechanism 493 includes a guide member 401, a main scanning motor 405, a timing belt 408, and the like. The guide member 401 is bridged between left and right side plates 491A and 491B to movably hold the carriage 403.

Then, the carriage 403 is reciprocated in the main scanning direction by the main scanning motor 405 via the timing belt 408 bridged between a driving pulley 406 and a driven pulley 407.

A liquid discharge unit 440 in which the liquid discharge head 1 according to the present disclosure and a head tank 441 are integrated is mounted on the carriage 403. The liquid discharge head 1 discharges color liquid of, for example, yellow (Y), cyan (C), magenta (M), and black (K).

In the liquid discharge head 1, a nozzle row including multiple nozzles is arranged in a sub-scanning direction orthogonal to the main scanning direction, and the liquid discharge head 1 is attached so that a discharge direction faces downward. The liquid discharge head 1 is connected to a liquid circulation apparatus, and liquid of a desired color is circulated and supplied.

The printing apparatus 500 includes a conveyance mechanism 495 for conveying a sheet 410. The conveyance mechanism 495 includes a conveyance belt 412 that is a conveyor, and a sub-scanning motor 416 that drives the conveyance belt 412. The conveyance belt 412 attracts the sheet 410 and conveys the sheet at a position facing the liquid discharge head 1. The conveyance belt 412 is an endless belt and is stretched between a conveyance roller 413 and a tension roller 414. The attraction can be performed by electrostatic attraction, air suction, or the like. Then, the conveyance belt 412 circulates in the sub-scanning direction as the conveyance roller 413 is rotationally driven via the timing belt 417 and the timing pulley 418 by the sub-scanning motor 416.

Furthermore, on one side in the main scanning direction of the carriage 403, a maintenance and recovery mechanism 420 that maintains and recovers the liquid discharge head 1 is arranged on the side of the conveyance belt 412. The maintenance and recovery mechanism 420 includes, for example, a cap member 421 that caps the nozzle surface of the liquid discharge head 1, a wiper member 422 that wipes the nozzle surface, and the like. The main scanning movement mechanism 493, the maintenance and recovery mechanism 420, and the conveyance mechanism 495 are attached to a housing including side plates 491A and 491B and a back plate 491C.

In the printing apparatus 500 configured as described above, the sheet 410 is fed onto the conveyance belt 412 and attracted, and the sheet 410 is conveyed in the sub-scanning direction by the circular movement of the conveyance belt 412. Then, by driving the liquid discharge head 1 according to an image signal while moving the carriage 403 in the main scanning direction, liquid is discharged onto the sheet 410 that is being stopped to form an image.

Next, another example of the liquid discharge unit according to the present disclosure will be described with reference to FIG. 17.

FIG. 17 is an explanatory plan view of a main portion of the liquid discharge unit according to the present example.

The liquid discharge unit 440 includes a housing portion including the side plates 491A and 491B and the back plate 491C, the main scanning movement mechanism 493, the carriage 403, and the liquid discharge head 1 among members constituting the liquid discharge apparatus.

The liquid discharge unit can be configured such that the maintenance and recovery mechanism 420 described above is further attached to, for example, the side plate 491B of the liquid discharge unit 440.

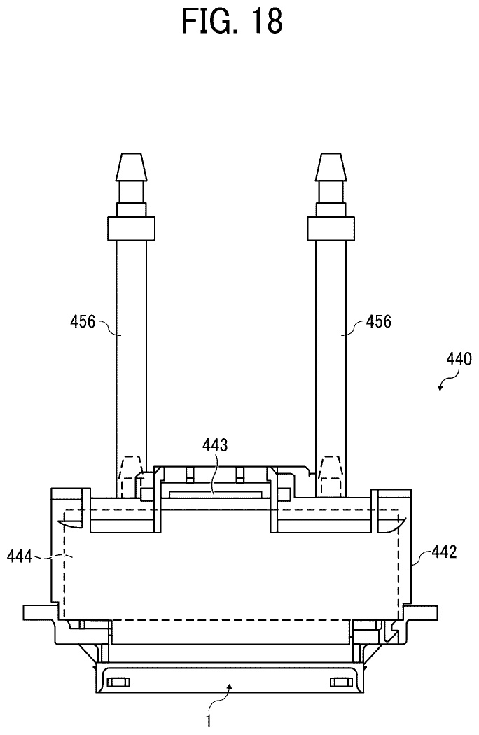

Next, still another example of the liquid discharge unit according to the present disclosure will be described with reference to FIG. 18.

FIG. 18 is an explanatory front view of the liquid discharge unit according to the present example.

The liquid discharge unit 440 includes a liquid discharge head 1 to which a channel component 444 is attached, and a tube 456 connected to the channel component 444.

The channel component 444 is arranged inside the cover 442. A head tank 441 may be included instead of the channel component 444. A connector 443 for electrical connection with the liquid discharge head 1 is provided above the channel component 444.

In the present application, the discharged liquid is not particularly limited as long as it has viscosity and surface tension at which the liquid can be discharged from the head, but it is preferable that the viscosity is 30 mPa·S or less at normal temperature and normal pressure, or by heating or cooling. More specific examples thereof include solutions, suspensions, and emulsions containing solvents such as water and organic solvents, colorants such as dyes and pigments, function-imparting materials such as polymerizable compounds, resins, and surfactants, biocompatible materials such as DNA, amino acids, proteins, and calcium, edible materials such as natural pigments, and the like. These can be used for, for example, inkjet ink, surface treatment liquid, constituent elements of electronic elements and light emitting elements, liquid for forming an electronic circuit resist pattern, material liquid for three-dimensional modeling, and the like.

The “liquid discharge unit” is formed by integrating functional components and mechanisms with a liquid discharge head, and includes an assembly of components related to liquid discharge. For example, the “liquid discharge unit” includes a combination of a liquid discharge head and at least one of components of a head tank, a carriage, a supply mechanism, a maintenance and recovery mechanism, a main scanning movement mechanism, and a liquid circulation apparatus.

Here, the integration includes, for example, a configuration in which the liquid discharge head, the functional components, and the mechanisms are fixed to each other by fastening, adhesion, engagement, or the like, and a configuration in which one is movably held with respect to the other. Further, the liquid discharge head, the functional components, and the mechanisms may be configured to be detachable from each other.

For example, as the liquid discharge unit, there is a unit in which a liquid discharge head and a head tank are integrated. Further, the liquid discharge head and the head tank may be integrally connected to each other by a tube, or the like. Here, it is also possible to add a unit including a filter between the head tank and the liquid discharge head of these liquid discharge units.

Further, as the liquid discharge unit, there is a unit in which a liquid discharge head and a carriage are integrated.

Further, as the liquid discharge unit, there is a unit in which a liquid discharge head is movably held by a guide member constituting part of the scanning movement mechanism, and the liquid discharge head and the scanning movement mechanism are integrated. Further, there is a unit in which the liquid discharge head, the carriage, and the main scanning movement mechanism are integrated.

Further, as the liquid discharge unit, there is a unit in which a cap member as part of a maintenance and recovery mechanism is fixed to a carriage to which a liquid discharge head is attached, and the liquid discharge head, the carriage, and the maintenance and recovery mechanism are integrated.

Further, as the liquid discharge unit, there is a unit in which a tube is connected to a liquid discharge head to which a head tank or a channel component is attached, and the liquid discharge head and a supply mechanism are integrated. Liquid of a liquid storage source is supplied to the liquid discharge head through the tube.

The main scanning movement mechanism also includes a single guide member. Further, the supply mechanism also includes a single tube and a single loading unit.

Here, the “liquid discharge unit” is described in combination with the liquid discharge head, but the “liquid discharge unit” includes a head module including the above-described liquid discharge head or a unit in which the head unit and the above-described functional components and mechanisms are integrated.

The “liquid discharge apparatus” includes an apparatus that includes a liquid discharge head, a liquid discharge unit, a head module, a head unit, and the like, and drives the liquid discharge head to discharge liquid. Examples of the liquid discharge apparatus include not only an apparatus capable of discharging liquid to an object to which liquid can adhere but also an apparatus that discharges liquid toward air or liquid.

The “liquid discharge apparatus” may also include a unit related to feeding, conveying, and sheet ejection of an object to which liquid can adhere, a preprocessing apparatus, a post-processing apparatus, and the like.

For example, examples of the “liquid discharge apparatus” include an image forming apparatus that discharges ink to form an image on a sheet, and a stereoscopic fabrication apparatus (three-dimensional fabrication apparatus) that discharges fabrication liquid to a powder layer obtained by forming powder into a layer in order to fabricate a stereoscopic fabrication object (three-dimensional fabrication object).

In addition, the “liquid discharge apparatus” is not limited to an apparatus in which a meaningful image such as a character or a figure is visualized by the discharged liquid. For example, the “liquid discharge apparatus” includes also an apparatus that forms a meaningless pattern, or the like, and an apparatus that forms a three-dimensional image.

The “object to which liquid can adhere” means an object to which liquid can at least temporarily adhere, an object to which liquid adheres and is fixed, an object to which liquid adheres and permeates, or the like. Specific examples include recording media such as paper, recording paper, recording paper, films, and cloth, electronic components such as electronic substrates and piezoelectric elements, and media such as powder layers (powder layers), organ models, and inspection cells, and include all those to which liquid adheres unless otherwise specified.

The material of the “object to which liquid can adhere” may be any material as long as liquid can adhere even temporarily, such as paper, thread, fiber, cloth, leather, metal, plastic, glass, wood, or ceramics.

Further, the “liquid discharge apparatus” may be an apparatus in which the liquid discharge head and the object to which the liquid can adhere move relative to each other, but is not limited thereto. Specific examples include a serial type apparatus in which the liquid discharge head moves, a line type apparatus in which the liquid discharge head does not move, and the like.

In addition, another example of the “liquid discharge apparatus” is a treatment liquid application apparatus that discharges treatment liquid onto a sheet in order to apply the treatment liquid to the surface of the sheet for the purpose of modifying the surface of the sheet. In addition, there is also an injection granulation apparatus that injects composition liquid in which a raw material is dispersed in a solution through nozzles to granulate fine particles of the raw material.

A liquid discharge head (1) incudes a nozzle plate (110) having multiple nozzles (2); multiple individual channels (4) respectively communicating with the multiple nozzles (2); multiple actuators (5) in the nozzle plate; a common channel (3); and a damper chamber. The multiple actuators (5) respectively surround the multiple nozzles (4), to deform the nozzle plate to discharge a liquid in the multiple individual channels (4) from the multiple nozzles. The common channel (3) communicates with each of the multiple individual channels (4). The damper chamber communicates with the common channel (3); faces the nozzle plate (110); and is independent from each of the multiple individual channels (4).

The damper chamber (6) has the same structure; and the same size, as a structure and a size of the multiple individual channels (4).

The damper chamber (6) faces a portion of the nozzle plate (110) that does not have a nozzle of the multiple nozzles.

The multiple nozzles have first openings (4a) respectively communicating with the multiple individual channels (4); and a second opening having the same structure and the same size as the first openings. The damper chamber (6) faces a portion of the nozzle plate (110) that has the second opening.

The multiple nozzles have: first openings (4a) respectively communicating with the multiple individual channels (4); and a second opening having a structure and a size different from the first openings. The multiple individual channels (4) face a portion of the nozzle plate having the first openings and a first compliance. The damper chamber (6) faces another portion of the nozzle plate (110) that has the second opening having a second compliance larger than the first compliance.

The liquid discharge head further includes multiple damper chambers including the damper chamber. The common channel includes: a first common channel portion communicating with two or more of the multiple individual channels; and a second common channel portion communicating with two or more of the multiple individual channels not communicating with the first common channel portion. A number of the multiple individual channels communicating with the second common channel portion is smaller than a number of the multiple individual channels communicating with the first common channel portion. The damper chambers communicate with the second common channel portion, and a total number of the multiple individual channels and the multiple damper chambers communicating with the second common channel portion is equal to the number of the individual channels communicating with the first common channel portion.

The liquid discharge head further comprising multiple damper chambers including the damper chamber. The common channel includes: a first common channel portion communicating with two or more of the multiple individual channels; and a second common channel portion communicating with two or more of the multiple individual channels not communicating with the first common channel portion. A number of the multiple individual channels communicating with the second common channel portion is smaller than a number of the multiple individual channels communicating with the first common channel portion. The damper chambers communicate with the second common channel portion.

The common channel includes a supply channel that communicates with the multiple individual channels, through which the liquid is supplied to the multiple individual channels; and a discharge channel that communicates with the multiple individual channels, through which the liquid is discharged from the multiple individual channels.

The liquid discharge head further includes multiple damper chambers including the damper chamber. The multiple individual channels are two-dimensionally arranged along a surface parallel to a plate surface of the nozzle plate. The damper chambers are provided along at least part of an outer peripheral portion of an individual channel region in which the multiple individual channels is arranged.

The liquid discharge head further includes multiple damper chambers including the damper chamber. The multiple individual channels are two-dimensionally arranged along a surface parallel to a plate surface of the nozzle plate. The damper chambers are provided in an inner portion of an individual channel region in which the multiple individual channels are arranged.

A liquid discharge apparatus includes the liquid discharge head described above.

Note that, in the terms of the present application, image formation, recording, printing, photographic printing, shaping, and the like, are all synonymous.

The embodiment described above is one example, and the various aspects of the present disclosure attain respective effects as follows.

### First Aspect

According to a first aspect, a liquid discharge head 1 includes: multiple nozzles 2 formed in a nozzle plate 110; multiple individual channels 4 respectively communicating with the multiple nozzles; multiple actuators (for example, piezoelectric elements 5) provided in the nozzle plate for each of the multiple individual channels; and a common channel 3 (for example, supply common channel portions 3a and 3a′ and discharge common channel portions 3b and 3b′) communicating with the multiple individual channels, the liquid discharge head 1 discharging liquid (for example, ink) in the individual channels from the nozzles by driving the actuators to displace the nozzle plate, and damper liquid chambers 6 communicating with the common channel and facing the nozzle plate being provided separately from the multiple individual channels.

If a pressure wave or pressure fluctuation of the liquid generated in each of the individual channels by driving of the actuators is propagated to the other individual channels via the common channel, the pressure of the liquid in the other individual channels may fluctuate, and crosstalk that affects discharge of the liquid in the other individual channels from the nozzles may occur. In a liquid discharge head in related art, a new damper member is arranged between the individual channels and the common channel, and a pressure wave or pressure fluctuation (crosstalk pressure) of the liquid generated in the individual channels is absorbed by the damper member, thereby crosstalk is reduced. However, in the liquid discharge head in the related art, an arrangement space is provided for the damper member to be newly arranged, which leads to increase in size of the apparatus.

Here, in a liquid discharge head of a so-called nozzle plate vibration type in which the actuators are provided on the nozzle plate, the actuators is driven to displace the nozzle plate, and thus, a nozzle plate with high compliance is used. The present inventors have found that such a nozzle plate with high compliance can exhibit a damper function, and have found that crosstalk can be reduced or prevented by using an existing nozzle plate as a damper member without arranging a new damper member.

Thus, in the present aspect, the damper liquid chambers facing the nozzle plate are provided separately from the multiple individual channels, and the damper liquid chambers communicate with the common channel. According to this, the crosstalk pressure of the liquid generated in each of the individual channels is propagated to the damper liquid chambers via the common channel, and is absorbed by the nozzle plate with high compliance facing the damper liquid chambers. As a result, the crosstalk pressure propagated through the common channel decreases, and the crosstalk can be reduced or prevented. Thus, according to the present aspect, it is possible to reduce or prevent crosstalk by using the existing nozzle plate as a damper member without arranging a new damper member, and thus, it is possible to reduce or prevent crosstalk without increasing the size of the apparatus.

### Second Aspect

According to a second aspect, in the liquid discharge head of the first aspect, the damper liquid chambers have the same configuration as the individual channels.

According to this, the damper liquid chambers can be formed in the same process as the process of forming the individual channels, and the manufacturing process can be simplified. In addition, the damper liquid chambers communicating with the common channel can behave substantially in the same manner as the individual channels, and the liquid discharge state from the nozzles can be easily made uniform.

### Third Aspect

According to a third aspect, in the liquid discharge head of the second aspect, openings are not provided in a nozzle plate portion facing the damper liquid chambers.

According to this, the manufacturing of the damper liquid chambers can be simplified as compared with the case where the openings are formed in the damper liquid chambers.

### Fourth Aspect

According to a fourth aspect, in the liquid discharge head of the second aspect, openings having the same structure as a structure of the nozzles are provided in a nozzle plate portion facing the damper liquid chambers.

According to this, the openings can be formed in the damper liquid chambers in the same process as the process of forming the nozzles, and the manufacturing process can be simplified. In addition, the damper liquid chambers communicating with the common channel can behave substantially in the same manner as the individual channels, and the liquid discharge state from the nozzles can be easily made uniform.

### Fifth Aspect

According to a fifth aspect, in the liquid discharge head of the second aspect, openings having a structure different from a structure of the nozzles are provided in a nozzle plate portion facing the damper liquid chambers, and the structure of the openings is set such that a total compliance of a meniscus formed in the openings and the nozzle plate portion becomes maximum.

According to this, a high damper effect in the damper liquid chamber can be obtained.

### Sixth Aspect

According to a sixth aspect, in the liquid discharge head of any one of the second to fifth aspects, the common channel includes a first common channel portion (for example, the other supply common channel portion 3a and the other discharge common channel portion 3b) communicating with two or more individual channels among the multiple individual channels, and a second common channel portion (for example, the supply common channel portion 3a′ and the discharge common channel portion 3b′) communicating with individual channels not communicating with the first common channel portion among the multiple individual channels, the number of the individual channels communicating with the second common channel portion being smaller than the number of the individual channels communicating with the first common channel portion. The damper liquid chambers communicate with the second common channel portion, and a total number of the individual channels and the damper liquid chambers communicating with the second common channel portion is equal to the number of the individual channels communicating with the first common channel portion.

The compliance of the nozzle plate portion facing the individual channels is different between the first common channel portion and the second common channel portion for which the numbers of communicating individual channels are different from each other. Thus, the behavior of displacement or vibration of the nozzle plate by driving of the actuators is different from each other, and the liquid discharge state from the nozzles is different from each other.

According to the present aspect, by providing the damper liquid chambers, it is possible to reduce or eliminate a difference in compliance of the nozzle plate portion facing the individual channels between the first common channel portion and the second common channel portion. As a result, the liquid discharge state from the nozzles between the first common channel portion and the second common channel portion can be made uniform.

### Seventh Aspect

According to a seventh aspect, in the liquid discharge head of any one of the first to fifth aspects, the common channel includes a first common channel portion communicating with two or more individual channels among the multiple individual channels, and a second common channel portion communicating with individual channels not communicating with the first common channel portion among the multiple individual channels, the number of the individual channels communicating with the second common channel portion being smaller than the number of the individual channels communicating with the first common channel portion, and the damper liquid chambers communicate with the second common channel portion.

The compliance of the nozzle plate portion facing the individual channels is different between the first common channel portion and the second common channel portion for which the numbers of communicating individual channels are different from each other. Thus, the behavior of displacement or vibration of the nozzle plate by driving of the actuators is different from each other, and the liquid discharge state from the nozzles is different from each other.

According to the present aspect, by providing the damper liquid chambers, it is possible to reduce a difference in compliance of the nozzle plate portion facing the individual channels between the first common channel portion and the second common channel portion. As a result, the liquid discharge state from the nozzles between the first common channel portion and the second common channel portion can be made uniform.

### Eighth Aspect

According to an eighth aspect, in the liquid discharge head of any one of the first to seventh aspects, the common channel includes a supply channel (for example, the supply common channel portions 3a and 3a') that communicates with the multiple individual channels and through which liquid to be supplied to the multiple individual channels flows, and a discharge channel (for example, the discharge common channel portions 3b and 3b′) that communicates with the multiple individual channels and through which liquid to be discharged from the multiple individual channels flows.

According to this, a liquid discharge head of a liquid circulation type can be provided.

### Ninth Aspect

According to a ninth aspect, in the liquid discharge head of any one of the first to eighth aspects, the multiple individual channels is two-dimensionally arranged along a surface parallel to a plate surface of the nozzle plate, and the damper liquid chambers are provided along at least part of an outer peripheral portion of an individual channel region B in which the multiple individual channels is arranged.

According to this, the liquid discharge state from the nozzles of the individual channels (the individual channels located in the outer peripheral portion of the individual channel region B) adjacent to the damper liquid chambers can be brought close to the liquid discharge state from the nozzles of the individual channels (the individual channels surrounded by other individual channels) located in the inner portion of the individual channel region B. As a result, the liquid discharge state from the nozzles can be made uniform.

### Tenth Aspect

According to a tenth aspect, in the liquid discharge head of any one of the first to ninth aspects, the multiple individual channels is two-dimensionally arranged along a surface parallel to a plate surface of the nozzle plate, and the damper liquid chambers are provided in an inner portion of an individual channel region in which the multiple individual channels is arranged.

According to this, the liquid discharge state from the nozzles of the individual channels adjacent to the damper liquid chambers can be brought close to the liquid discharge state from the nozzles of the individual channels surrounded by other individual channels. As a result, the liquid discharge state from the nozzles can be made uniform.

### Eleventh Aspect

According to an eleventh aspect, a liquid discharge apparatus includes the liquid discharge head of any one of the first to the tenth aspects.

According to this, it is possible to provide a liquid discharge apparatus capable of reducing or preventing crosstalk without increasing the size of the apparatus.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A liquid discharge head comprising:
a nozzle plate having multiple nozzles;
multiple individual channels respectively communicating with the multiple nozzles;
multiple actuators in the nozzle plate,
the multiple actuators respectively surrounding the multiple nozzles,
to deform the nozzle plate to discharge a liquid in the multiple individual channels from the multiple nozzles;
a common channel communicating with each of the multiple individual channels; and
a damper chamber:
communicating with the common channel;
facing the nozzle plate; and
independent from each of the multiple individual channels.

2. The liquid discharge head according to claim 1, wherein:
the damper chamber has:
the same structure; and
the same size,
as a structure and a size of the multiple individual channels.

3. The liquid discharge head according to claim 2, wherein:
the damper chamber faces a portion of the nozzle plate that does not have a nozzle of the multiple nozzles.

4. The liquid discharge head according to claim 2, wherein:
the multiple nozzles have:
first openings respectively communicating with the multiple individual channels; and
a second opening having the same structure and the same size as the first openings, and
the damper chamber faces a portion of the nozzle plate that has the second opening.

5. The liquid discharge head according to claim 2, wherein:
the multiple nozzles have:
first openings respectively communicating with the multiple individual channels; and
a second opening having a structure and a size different from the first openings,
the multiple individual channels face a portion of the nozzle plate having the first openings and a first compliance; and
the damper chamber faces another portion of the nozzle plate that has the second opening having a second compliance larger than the first compliance.

6. The liquid discharge head according to claim 2, further comprising multiple damper chambers including the damper chamber, wherein:
the common channel includes:
a first common channel portion communicating with two or more of the multiple individual channels; and
a second common channel portion communicating with two or more of the multiple individual channels not communicating with the first common channel portion,
a number of the multiple individual channels communicating with the second common channel portion is smaller than a number of the multiple individual channels communicating with the first common channel portion,
the damper chambers communicate with the second common channel portion, and
a total number of the multiple individual channels and the multiple damper chambers communicating with the second common channel portion is equal to the number of the individual channels communicating with the first common channel portion.

7. The liquid discharge head according to claim 1, further comprising multiple damper chambers including the damper chamber, wherein:
the common channel includes:
a first common channel portion communicating with two or more of the multiple individual channels; and
a second common channel portion communicating with two or more of the multiple individual channels not communicating with the first common channel portion,
a number of the multiple individual channels communicating with the second common channel portion is smaller than a number of the multiple individual channels communicating with the first common channel portion, and
the damper chambers communicate with the second common channel portion.

8. The liquid discharge head according to claim 1, wherein:
the common channel includes:
a supply channel that communicates with the multiple individual channels,
through which the liquid is supplied to the multiple individual channels; and
a discharge channel that communicates with the multiple individual channels
through which the liquid is discharged from the multiple individual channels.

9. The liquid discharge head according to claim 1, further comprising multiple damper chambers including the damper chamber, wherein:
the multiple individual channels are two-dimensionally arranged along a surface parallel to a plate surface of the nozzle plate, and
the damper chambers are provided along at least part of an outer peripheral portion of an individual channel region in which the multiple individual channels is arranged.

10. The liquid discharge head according to claim 1, further comprising multiple damper chambers including the damper chamber, wherein:
the multiple individual channels are two-dimensionally arranged along a surface parallel to a plate surface of the nozzle plate, and
the damper chambers are provided in an inner portion of an individual channel region in which the multiple individual channels are arranged.

11. A liquid discharge apparatus comprising the liquid discharge head according to claim 1.
